(19) United States
(12) Patent Application Publication
(10) Pub. No.: US 2009/0118899 A1
(43) Pub. Date: May 7, 2009

(54) METHOD AND APPARATUS FOR SECURE STORAGE AND REMOTE MONITORING VEHICLE ODOMETER

(76) Inventor: Jim Carlson, Griffith, IN (US)

Correspondence Address: SNELL & WILMER LLP (OC), 600 ANTON BOULEVARD, SUITE 1400, COSTA MESA, CA, 92626, US

(21) Appl. No.: 11/914,069

(22) PCT Filed: May 11, 2006
(86) PCT No.: PCT/US06/18287

§ 371 Date: Jan. 13, 2009

Related U.S. Application Data
(60) Provisional application No. 60/679,678, filed on May 11, 2005.

(51) Int. Cl. G01C 22/00

(52) U.S. Cl. 701/35

(57) ABSTRACT

The disclosure generally relates to a method for remote reading the tamper-proof storage of the odometer reading in a vehicle by, for example, making available an alternative wireless method for the accessing of odometer reading data. In one embodiment, the disclosure relates to a method for remotely reading odometer data in a vehicle having control units which are connected via a data bus. The odometer reading data, which is determined at a particular time by an odometer, can be stored in a storage means of a first control unit, thereby providing an alternative method for remotely accessing odometer reading data and, in particular, improved protection against errors during the transmission of the odometer reading data. The current odometer reading data of at least one further control unit is then stored on the data bus in a storage means. The control units transmit the odometer reading data, which is stored at a particular time, onto the data bus at specific time intervals, and a control unit accepts the odometer reading transmitted onto the data bus if that reading is higher than its stored value, and uses that value for the further counting and radio transmission of odometer reading data.

The instant disclosure claims the filing-date priority benefit of Provisional Application No. 60/679,678 filed May 11, 2005, the specification of which is incorporated herein in its entirety; the instant application also relates to PCT application Ser. No. ______ filed May 3, 2006 by the instant inventor, the specification of which is incorporated herein in its entirety for background information.

### BACKGROUND

Many stakeholders in a modern economy depend upon reliable storage and retrieval of the vehicle's odometer data as well as other pertinent information stored in the vehicle's electronic system. Owners require an accurate indication of mileage to ensure maintenance is timely performed. Insurance companies and law enforcement agencies depend on accurate odometer readings for actuarial data and accident reconstruction. Buyers need an accurate representation of mileage to make informed decisions when purchasing used vehicles. Due to the critical importance of this data and the increasing proliferation of automobiles, several techniques have been developed in the art to ensure reliability and accuracy.

Conventional odometers utilize a variety of digital circuits to store and verify mileage readings. It is known in the art to accumulate and update odometer readings in a nonvolatile memory. This technique stores accumulated mileage data utilizing optimized addressing thereby avoiding unnecessary write/delete access operations. This technique can also implements error checking by setting and checking an additional parity bit for each stored data value.

It is conventionally known to implement tamper-proof storage for odometers. This task has been performed by setting an additional flag during the memory write operation that can not be deleted. The additional flag may then be verified during the memory read operations. Alternatively, it is known that odometer data may be encrypted in the counting unit and transmitted to a receiver unit. The receiver unit can then decrypt the data and store accumulated mileage. It is also known that the odometer reading may be stored in separate digital units (i.e., a display unit, a processor unit, and a non-volatile memory unit). If tampering is detected in a first digital unit (i.e., the non-volatile memory unit), the odometer reading in a second digital unit (i.e., the processor unit) may be written back into the first digital unit.

The mileage information is generally stored in the vehicle electronic control unit (“ECU”) that is not accessible by anyone other than an authorized technician and/or dealer. As a result, GPS waypoints, speed sensor or other algorithms have been used to determine true mileage of the vehicle if the odometer reading is suspect. These methods have proved costly and inaccurate.

Conventional technology fails to provide a tamper-proof backup system. Despite the numerous external uses of odometer data, all sources of this data are fully encapsulated within the vehicle. Likewise, conventional methods fail to teach means for robust error detection and correction. Parity bits provide a limited and elementary form of error detection and fails to provide the necessary level of accuracy. Furthermore, it is desirable for external parties to have access to this data without having to go to an authorized dealer technician. Therefore, there is a need for redundant, secure, and remote storage of vehicular mileage data.

### SUMMARY

The disclosure generally relates to a method for secure storage and remote monitoring of the odometer in a vehicle. In one embodiment, the disclosure provides a process and architecture for encryption, decryption, secure transmission, redundant tamper-proof storage and error checking of vehicular mileage readings.

In another embodiment, the disclosure relates to utilizing a binary file that is uploaded (or flashed) into the ECU system. The binary file independently allows the mileage information to be transmitted to the bus system or to an auxiliary system, such as a radio modem or a secondary bus system for collection and processing.

In still another embodiment, the disclosure relates to a method and system for uploading a binary (BIN) file to the ECU. The BIN file uses a unique protocol/language or algorithm configured such that aftermarket peripheral devices can communicate directly with the ECU using the peripheral devices' protocol/language. In this manner the BIN file can act as a translator. Thus, the ECU itself can be used to process information and communication with the various protocols and sub-systems that exist on a vehicle. The BIN file allows subscriber to obtain mileage as well as other vital information, avoid expensive hardware costs and eliminate the need for the technicians to learn new protocols that may exist on the Controller Area Network (“CAN”) of the vehicle.

According to one embodiment, the disclosure relates to a method for providing secure storage and remote monitoring of odometer reading data, said method comprising the steps of a first control unit monitoring an odometer and storing odometer reading data in a first memory storage at a particular time interval, said first control unit encrypting the odometer reading data and transmitting said encrypted data onto a data bus; a second control unit receiving said encrypted data, decrypting said data and evaluating said data for errors and correctness; said second control unit accepting said data if it passes the checks errors and correctness and said second control unit storing said accepted data in non-volatile memory and transmitting the data via wireless radio communications to a remote computer network.

### BRIEF DESCRIPTION OF THE DRAWINGS

The principles of the disclosure will be described in relation to exemplary and non-limiting drawings in which:

FIG. 1 is a schematic diagram illustrating one embodiment of the disclosure;

FIG. 2 is a schematic diagram representing an exemplary method according to one embodiment of the disclosure; and

FIG. 3 is a schematic representation of a system according to one embodiment of the disclosure.

### DETAILED DESCRIPTION

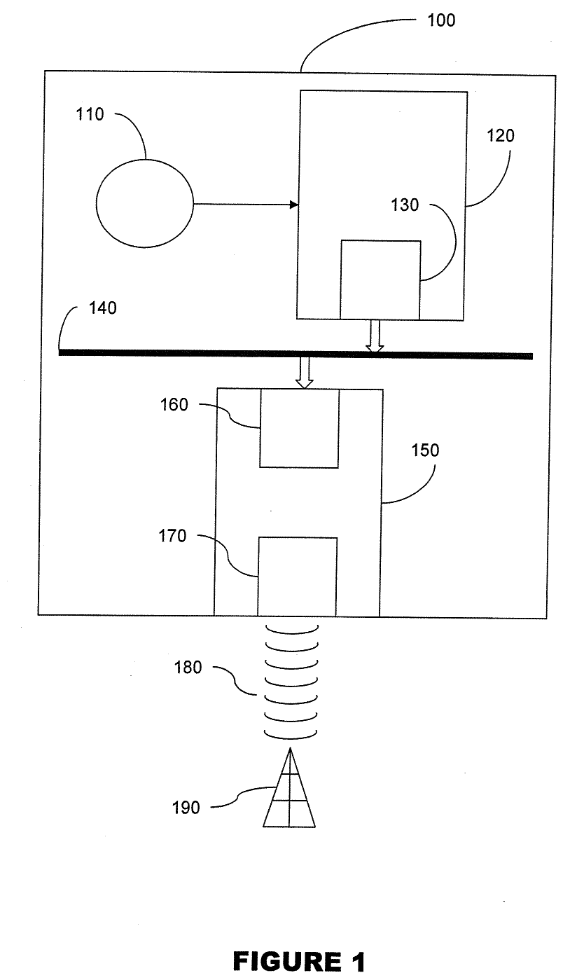

FIG. 1 is a schematic diagram of a system for implementing a method according to one embodiment of the disclosure. Specifically, FIG. 1 shows system 100 having an odometer 110, a first control unit 120, a data bus 140, and a second control unit 150. System 100 can be included in the vehicle electronic control unit (“ECU”) or it can be implemented as separate hardware and software combination somewhere within the vehicle. First control unit 120 is connected to and receives mileage reading data from odometer 110. First control unit 120 can be adapted to electronically communicate with the vehicle's odometer as well as other electronic components of the vehicle. The first control unit may be configured to communicate with the vehicle odometer wirelessly. The first control unit can comprise a software and/or hardware program added to the vehicle's ECU. In another embodiment, the first control unit can define a distinct electronic module added as an aftermarket part to the vehicle. In still another embodiment, the first control unit can be a software with virtual memory that is configured to reside on an existing processor in the vehicle.

At a predetermined time interval, first control unit 120 may receive mileage data from the odometer or from a secondary source in the vehicle. In one embodiment, the data is then encrypted and stored for future use. In another embodiment, the encrypted (or un-encrypted) data is directed to data bus 140 through first data interface connection 130. The periodic nature of data receipt and/or transmission can be varied according to the system administrator's needs. In one exemplary embodiment, the first control unit can collect data continuously and in real-time. In another embodiment, the data-collection interval can be set at, for example, 5 minute intervals. In still another embodiment, the data can be collected each time the vehicle's engine is turned on.

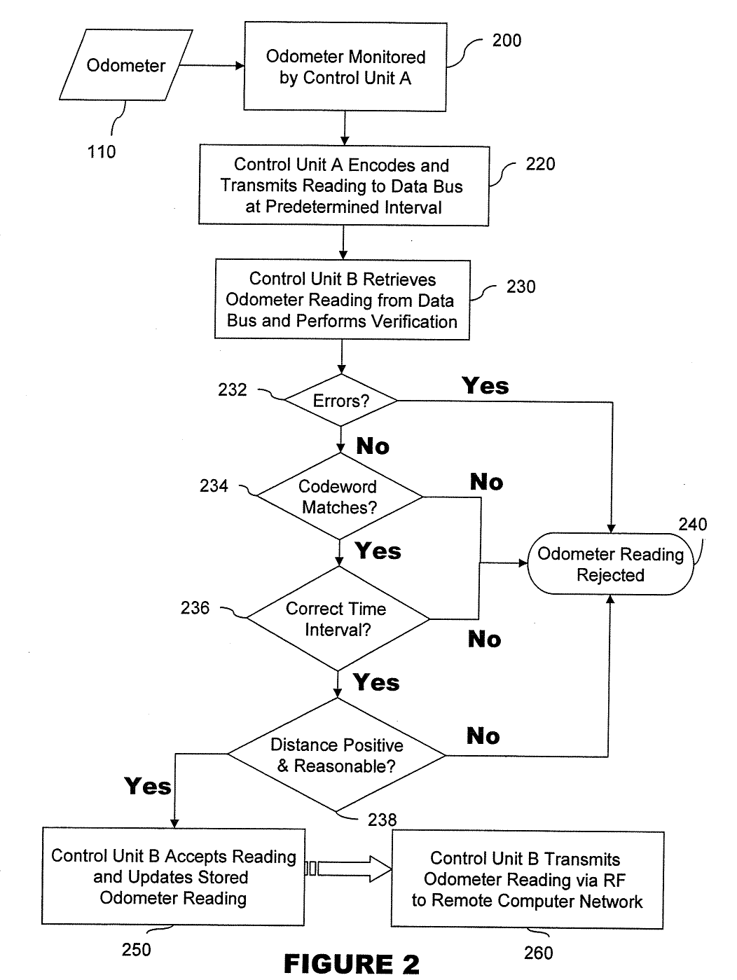

Second control unit 150 may retrieve encrypted data from data bus 140 via second data interface connection 160. The second control unit can decrypt the data and perform several checks as exemplified in FIG. 2. If the retrieved data passes one or more authentication checks, then second control unit 150 can accept the mileage reading data and store the reading in non-volatile memory. Any of the conventional system for data authentication, such as parity check, can be used.

It should be noted that FIG. 1 shows an apparatus according to one exemplary embodiment of the disclosure. Accordingly, in another embodiment of the disclosure a device may exclude bus 140 and interfaces 130 and 160; thereby allowing the first and second control units to communicate directly with each other. In still another embodiment, the first and second control units communicate wirelessly after an authentication handshake is performed. In still another embodiment, the odometer reading is reported by the first control unit to a web address which can then be accessed by an administrator. In still a further embodiment, the second control unit 150 may transmit accepted mileage reading data through a wireless communications transceiver 170 via RF 180 to a remote computer network 190 for redundant storage and remote monitoring.

FIG. 2 is an exemplary diagram representing a method according to one embodiment of the disclosure. The method can be implemented, for example, in the embodiment of FIG. 1. In particular, the block diagram of FIG. 2 can be implemented in the processors of first control unit 120 and second control unit 150 of FIG. 1.

In step 200, a control unit monitors the mileage data readings of the odometer 110. The monitoring step can be implemented in a pull or a push manner. In the so-called pull embodiment, the control unit passively monitors odometer reading reported by the vehicle's odometer or any electronic unit reporting the odometer reading. According to this embodiment, the control unit parasitically takes advantage of the odometer reading information without interrupting or interfering the vehicle's normal operation. In the so-called push embodiment, the control unit queries the vehicle for odometer information. Here, the control unit may contact the ECU, the odometer or any other module that receives or can receive the odometer reading.

In step 220, the control unit encrypts and transmits the odometer reading data onto a data bus at predetermined intervals. In the exemplary embodiment, this encryption may involve encoding the data with a code word that is unique for the vehicle. Any other conventional encryption technique known in the art may be utilized. In one embodiment, authentication between the first and the second control units may include public-key and private-key encryption algorithm. A second control unit retrieves the encrypted data from the data bus in step 230 and performs a data verification process.

In one embodiment, the vehicle's existing communication system, such as the On-board Diagnostic (“OBD”) connector plug is used to convey information to or from the control unit. A conventional OBD or the new generation OBD II (collectively, OBD) is a serial bus (or a port) with a 16-cavity connector which enable a peripheral processor to read information stored in the ECU. According to this embodiment, the control unit can use non-invasive and non-conflicting protocol consistent with vehicle's own proprietary format and protocol so as not to disrupt OBD's normal operations. In an alternative embodiment, the control unit can use a different protocol and/or format for reporting the odometer data while using the OBD port or a secondary port.

The first step of data verification 232 may involve checking the data for errors utilizing conventional error checking techniques. This optional step can be important as there are a large number of possible sources of error. For example, as a result of a controller malfunction, a software error or hardware fault, spurious data could be injected onto the data bus. This spurious data could be interpreted as an odometer reading and result in cumulative errors in the stored odometer readings. This could lead to unintentional “aging” of a vehicles mileage.

If there are no errors, step 234 then verifies that the code word of the encryption matches the code word of the second control unit. This verification ensures that the data was received from the proper source and inhibits unauthorized tampering with stored odometer readings.

If the code words match, step 236 then verifies that the odometer data was transmitted at the correct predetermined time interval. This may be performed by checking that a message counter of the transmitted odometer reading is incremented in a predetermined manner from a plurality of successive time periods. This step further minimizes the possibility of spurious errors or intentional tampering with the odometer reading data.

If the odometer reading data was transmitted at the correct time interval, step 238 then verifies that the increment to the accumulated mileage data is positive and reasonable. Verifying whether the increment is reasonable may be done by ensuring that the difference between the odometer readings transmitted in a plurality of successive time periods does not exceed a predetermined distance which is characteristic of the vehicle or consistent with its traveling habits. This step can be very important due to the cumulative nature of the errors which could occur if a single high odometer reading were accepted.

The steps described above as 232, 234, 236 and 238 were described in a specific order for exemplary purposes only and may be performed in any order without departing from the spirit of the disclosure.

If the transmitted data fails any of the checks in steps 232, 234, 236, or 238 the odometer reading is rejected 240. If rejected, steps 200-230 can be repeated on an emergency basis or the system can wait for the next scheduled reading. Otherwise, the second control unit accepts the odometer reading data and updates the accumulated mileage data stored in memory 250. The memory can be volatile or non-volatile. Further, in step 260 the accumulated mileage reading data may be transmitted at a predetermined time interval via wireless radio communications to a remote computer network. This may allow external parties such as law enforcement agencies and maintenance facilities ready access to the data.

In another embodiment, the disclosure is directed to a method and apparatus for remote vehicle diagnosis, theft detection and odometer monitoring. The embodiment may optionally include an encryption system for accessing odometer data and for remote storage of backup copies of the odometer data. The conventional OBD wireless and diagnostic devices have limited compatibility with non-proprietary equipment such as peripheral devices. Further, wireless communications between the vehicle diagnostic, theft and control information can be intercepted, corrupted and re-transmitted with false information. Thus, an encryption security system can prevent false reports.

In another embodiment, the disclosure provides a secure wireless network transmission and receipt of vehicle diagnostic, vehicle control, and vehicle theft tracking information through vehicle computer interfacing, such as OBD connector, local radio links within the vehicle, vehicle optical interfaces, magnetic coupling and the like. If an existing vehicle OBD port is used, the interface characteristics of the OBD port may be revised to allow new interface pin configurations. Such configurations may include ISO, variable pulse width (VPW), pulse width modulation (PWM), and computer area network (CAN). Diagnostic data and vehicle control and alarm signals can be encrypted and decrypted at the appropriate ends of the bi-directional wireless communication. Software modifications can be implemented to allow interface with future vehicle communication schemes and flash memory can be included to allow remote reprogramming through encrypted communication.

In one embodiment a decoy OBD connector is provided to confound thieves intending to disable alarm systems, and to allow permanent installation of a preferred embodiment of the system while diagnostic scanners and the like may be temporally and simultaneously installed. The system components are modular to provide flexibility and cost reduction and may include multiband and multimode transceiver technologies useable in areas of poor cell phone reception. Thus, communication in alternate modes is possible when communication is compromised in some modes of operation.

In another embodiment, the disclosure includes a reliable storage system, internal to or external from a vehicle, to assure proper vehicle mileage data is maintained. The storage devices may include algorithms in a processor for identifying and rejecting improper odometer data that is caused by either a malicious intervention or by instrument-related errors. The algorithms may also include periodic sampling of odometer data that test for unusual and impermissible variations, such as lowering of mileage indication and changes in mileage indication beyond the maximum vehicle velocity capabilities.

In another embodiment, the disclosure relates to a secondary apparatus for detecting and reporting vehicle odometer data. The apparatus can be configured to be added by the manufacturer at the time of assembly or as an aftermarket part configured to use the vehicle's existing electronic infrastructure.

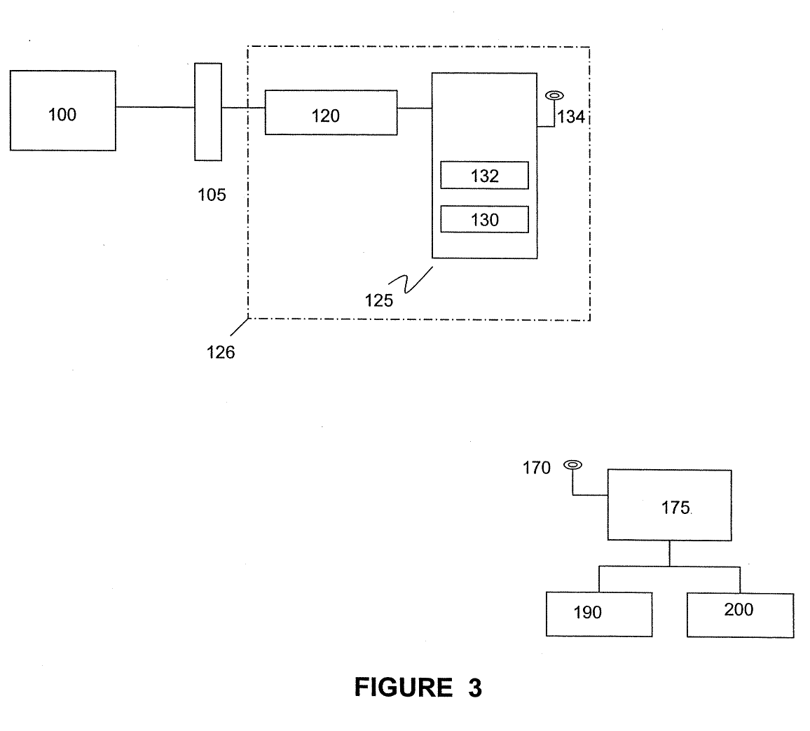

FIG. 3 is a schematic representation of a system according to one embodiment of the disclosure. In FIG. 3, the vehicle's internal computer system is represented in box 100. The internal computer system can be embodied in the ECU or any other electronic module or node capable of receiving or collecting performance information from the vehicle. The vehicle computer system 100 can be accessed by OBD port 105. The OBD port can be a conventional OBD port or it can an after-market addition to the vehicle. Translator port 120 is interposed between external computer 125 and OBD port 105. In one embodiment, translator port 120 can be configured by computer 125 such that the pins of the translator port are reassigned to accommodate communication with OBD 105, thereby enabling computer 125 to download information from internal computer system 100. Computer 125 and translation port 120 can be integrated into an operational unit, as indicated by broken lines 126. Such units may include handheld devices or mobile computers.

Because port 105 may have proprietary assigned pins, translator port 120 can be introduced to communicate with OBD port 105. Software can be added to unit 126 to translate information obtained from internal computer 100. Such information may be in proprietary format or protocol. Therefore, translation of the information can be necessary for deciphering the information. Alternatively, translator port 120 can be configured to automatically sense which OBD pin configuration is used and adapt itself to said configuration.

Mobile computer 125 may include additional modules 130 and 132 or it may include receptors for connection/addition of such modules. Mobile computer 125 may perform read/write processes on internal computer 100. Module 130 may include a modem for communicating data through antenna 134. Optional module 130 may comprise an integrated geo-positioning (“GPS”) receiver.

Once data is obtained and translated from internal computer 100, it can be optionally communicated to a secondary processor 175. System 175 can receive, decrypt (if information is encrypted by operation unit 126), and store information. If a wireless system is used, the information is transmitted by antenna 134 and received at antenna 170. Processor 175 is connected to support electronics 190 and peripheral devices 200. The processor can receive, process and store the information emanating from vehicle computer 100. The information can be used for diagnostic, tracking or reporting the vehicle's performance. In an embodiment where odometer data is collected, processor 175 can be, for example, an electronic storage site configured to receive and store mileage data. The storage site can be accessible through the internet to authorized subscribers.

Either processor 175 or computer 125 can be configured to analyze odometer information for authenticity and accuracy. For example, the processor can analyze the data to determine whether the odometer reading is consistent with the vehicle history or its previous readings. In addition, the processor can conduct various digital tests, such as parity testing, to determine whether the messages received from computer 125 are authentic.

While the exemplary representation of FIG. 3 provides vehicle connection through OBD port 105, the principles of the disclosure are not limited thereto. Indeed, a processor can be integrated with vehicle computer 100 and programmed to report odometer information through OBD port 105 or through wireless means specifically calculated to enable the vehicle to report information. In another embodiment, a secondary processor is positioned within the vehicle and is configured to communicate independently with internal computer system 100 through push and pull inquires described above.

In still another embodiment, a parasitic processor can be configured to tap into the vehicle's internal communication system to read vehicle odometer or to intercept internal odometer communications. The parasitic processor can then translate and communicate the information independently or store the information and report the same once queried.

In another embodiment, the parasitic processor comprises a virtual processor configured in software form to access internal computer system 100. The software can be loaded into the internal computer system (e.g., ECU) by the manufacturer or it can be added thereto as an aftermarket practice. As stated, the vehicle mileage information is stored at a location on the ECU that is generally inaccessible to anyone other than dealers and authorized technicians. In one embodiment of the disclosure, a binary file (BIN) is uploaded (or flashed) into the ECU allowing mileage and other viral information to be transmitted to the bus system for collection and processing. A CAN BIN file can be used where the BIN file includes a unique protocol/language (algorithm) such that the peripheral devices can communicate with the ECU in their native language and without the need for a translator. In this manner, the technician can obtain information from the ECU without having to use the manufacturers' proprietary hardware and software. The BIN file also enables the subscriber to use the ECU to process information and communication with the various protocols and sub systems that exist on the vehicle. The BIN file can be configured to communicate through the OBD port or wirelessly through a modem.

In one implementation of these concepts, the ECU can be tapped directly. Alternatively, a node in the vehicle's CAN may be accessed regardless of whether the node is active or passive. Conventional vehicles provide a CAN system wherein a plurality of nodes communicate in a closed system using a proprietary protocol. The CAN node embodiment disclosed herein is particularly suitable as method and apparatus whereby an aftermarket devise can be plugged into the CAN network of a vehicle such that a wide range of functions and features can be integrated into the existing closed CAN network. CAN systems identify nodes on their network and if a node is removed or added it typically creates a problem and the entire system will stop working properly.

For this reason, companies such as aftermarket audio system manufacturers are forced to leave the factory audio system plugged in so the CAN system does not see a change in the network. They then connect their aftermarket unit to the vehicle through the factory system. The same applies to alarms, navigation systems and entertainment systems.

In one embodiment, the BIN file or the auxiliary processor module mimics or creates a virtual node which the CAN network acknowledges and assumes should be present. Pursuant to the embodiments disclosed herein, such devices can be added to the CAN vis-à-vis the BIN file without disrupting its operation. Indeed, the BIN file can condition the ECU such that it either does not see the added node or it recognizes the added node as an existing node or as a viable new node.

The specific embodiments presented herein are exemplary in nature and are not intended to limit the scope of the disclosure. Any permutation, modification or deviation from the specific embodiments is considered to be well within the scope of the principles disclosed herein.

What is claimed is:

1. A method for remotely accessing odometer data in a vehicle having at least two control units which are each connected via a data bus, wherein the odometer reading data, which is determined at a particular time by means of an odometers is stored in a first storage means of a first one of said at least two control units, said method comprising the steps of:
storing the current odometer reading data of at least a second one of said at least two control units on the data bus in a second storage means,
transmitting remotely via radio frequency communications by at least one of two control units, the odometer reading data, which is stored at a particular time, from the data bus at specific time intervals, and
accepting in data of one of said control units, the odometer reading transmitted onto the data bus if said reading is higher in value than a stored value, and using said value for the further counting and storage in said one control unit.

2. The method according to claim 1, wherein, before the acceptance of the odometer reading data, the odometer reading data transmitted on the data bus is checked for errors by one of said control units.

3. The method according to claim 2, wherein the odometer reading transmitted on the data bus is accepted only if a “code word” of the transmitted odometer reading is identical to a “code word” of the vehicle.

4. The method according to claim 2, wherein the odometer reading transmitted on the data bus is accepted only if a message counter of the transmitted odometer reading is incremented in a predetermined manner over a plurality of successive time periods.

5. The method according to claim 2, wherein the odometer reading which is transmitted on the data bus is accepted only if the difference between the odometer readings transmitted in a plurality of successive time periods does not exceed a predetermined distance which is characteristic of the vehicle.

6. The method according to claim 1, wherein the odometer reading which is transmitted on the data bus is accepted only if the difference between the odometer readings transmitted in a plurality of successive time periods does not exceed a predetermined distance which is characteristic of the vehicle.

7. The method according to claim 6, wherein the odometer reading transmitted on the data bus is accepted only if a code word of the transmitted odometer reading is identical to a code word of the vehicle.

8. The method according to claim 6, wherein the odometer reading transmitted on the data bus is accepted only if a message counter of the transmitted odometer reading is incremented in a predetermined manner over a plurality of successive time periods.

9. The method according to claim 1, wherein, when it is transmitted, the odometer reading data is supplemented with a “code word” which is uniquely defined for the vehicle, in order to ensure that the message has been transmitted by one of said units.

10. The method according to claim 9, wherein the odometer reading transmitted on the data bus is accepted only if a code word of the transmitted odometer reading is identical to a code word of the vehicle.

11. The method according to claim 9, wherein the odometer reading transmitted on the data bus is accepted only if a message counter of the transmitted odometer reading is incremented in a predetermined manner over a plurality of successive time periods.

12. The method according to claim 1, wherein, when it is transmitted, the odometer reading data is supplemented with a message counter whose value is a counter for the number of transmitted odometer reading data items of one of said control units.

13. The method according to claim 12, wherein the odometer reading transmitted on the data bus is accepted only if a message counter of the transmitted odometer reading is incremented in a predetermined manner over a plurality of successive time periods.
